(19) United States
(12) Patent Application Publication
(10) Pub. No.: US 2016/0044906 A1
(43) Pub. Date: Feb. 18, 2016

(54) Fishing Rod Holder Device

(71) Applicant: Anthony Simms, SR., Junction City, KS (US)

(72) Inventor: Anthony Simms, SR., Junction City, KS (US)

(21) Appl. No.: 14/457,870

(22) Filed: Aug. 12, 2014

(51) Int. Cl. A01K 97/10

(52) U.S. Cl. CPC A01K 97/10

(57) ABSTRACT

A fishing rod holder device supports a fishing rod above a ground surface. The device includes a first shaft having a top end and a bottom end. A second shaft is provided having an upper end and a lower end. The second shaft is positioned in spaced parallel relationship relative to the first shaft. The bottom end of the first shaft and the lower end of the second shaft are configured for insertion into a ground surface for elevating the top end of the first shaft and the upper end of the second shaft above the ground surface. A support assembly is coupled to the top end of the first shaft and the upper end of the second shaft. The support assembly is configured for receiving a fishing rod and supporting the fishing rod above the ground surface.

### BACKGROUND OF THE DISCLOSURE

### Field of the Disclosure

The disclosure relates to holder devices and more particularly pertains to a new holder device for supporting a fishing rod above a ground surface.

### SUMMARY OF THE DISCLOSURE

An embodiment of the disclosure meets the needs presented above by generally comprising a first shaft having a top end and a bottom end. A second shaft is provided having an upper end and a lower end. The second shaft is positioned in spaced parallel relationship relative to the first shaft. The bottom end of the first shaft and the lower end of the second shaft are configured for insertion into a ground surface for elevating the top end of the first shaft and the upper end of the second shaft above the ground surface. A support assembly is coupled to the top end of the first shaft and the upper end of the second shaft. The support assembly is configured for receiving a fishing rod and supporting the fishing rod above the ground surface.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a fishing rod holder device according to an embodiment of the disclosure.

FIG. 2 is a front view of an embodiment of the disclosure.

FIG. 3 is a bottom view of an embodiment of the disclosure.

FIG. 4 is a side view of an embodiment of the disclosure.

FIG. 5 is an in-use side view of an embodiment of the disclosure.

### DESCRIPTION OF THE PREFERRED EMBODIMENT

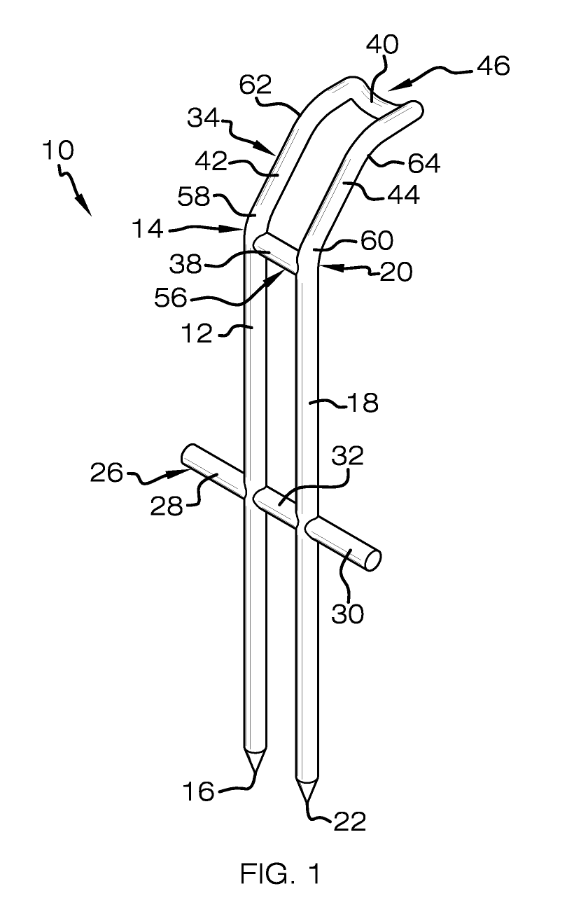

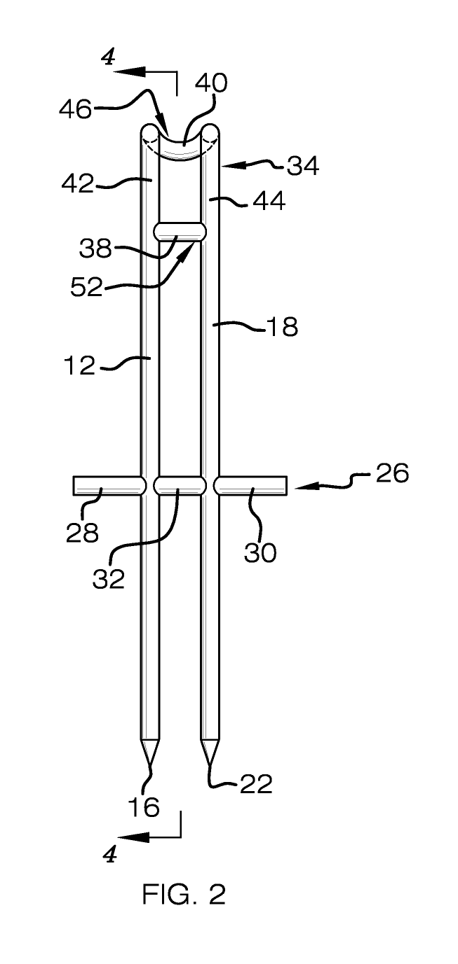

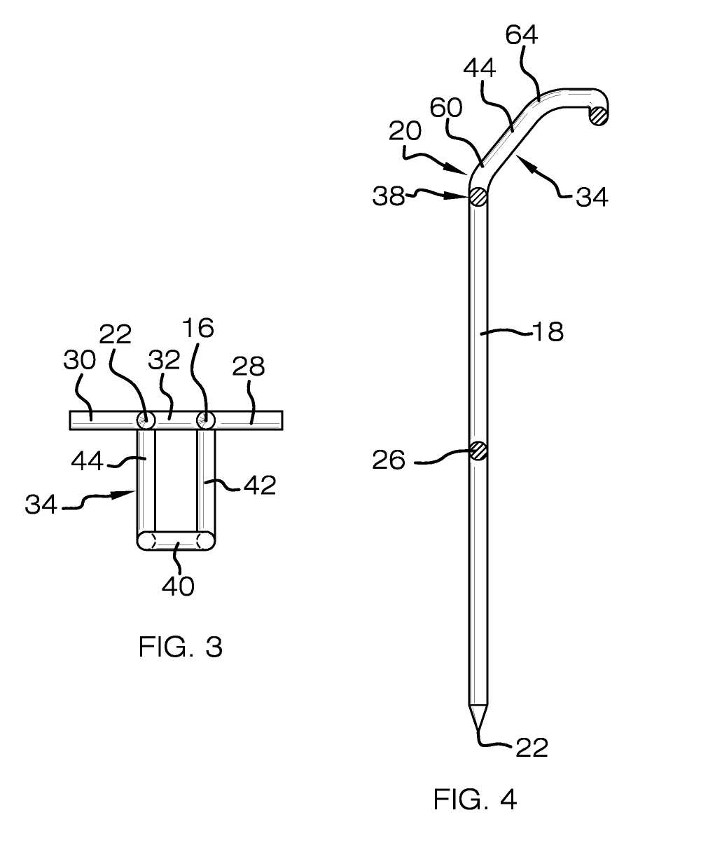

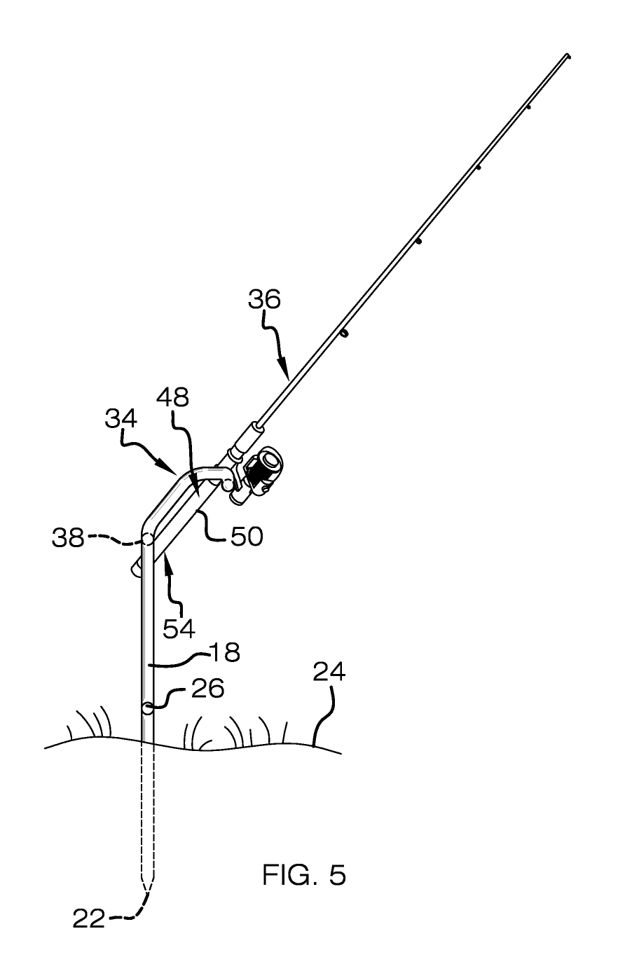

With reference now to the drawings, and in particular to FIGS. 1 through 5 thereof, a new holder device embodying the principles and concepts of an embodiment of the disclosure and generally designated by the reference numeral 10 will be described.

As best illustrated in FIGS. 1 through 5, the fishing rod holder device 10 generally comprises a first shaft 12 having a top end 14 and a bottom end 16. A second shaft 18 is provided having an upper end 20 and a lower end 22. The second shaft 18 is positioned in spaced parallel relationship relative to the first shaft 12. The bottom end 16 of the first shaft 12 and the lower end 22 of the second shaft 18 are each configured for insertion into a ground surface 24 for elevating the top end 14 of the first shaft 12 and the upper end 20 of the second shaft 18 above the ground surface 24. Each of the bottom end 16 of the first shaft 12 and the lower end 22 of the second shaft 18 may be pointed to facilitate driving the first 12 and second 18 shafts into the ground surface 24.

A foot step 26 is attached to each of the first shaft 12 and the second shaft 18. The foot step 26 is positioned between the top end 14 and the bottom end 16 of the first shaft 12 and between the upper end 20 and the lower end 22 of the second shaft 18 wherein exerting pressure on the foot step 26 is configured to drive the bottom end 16 of the first shaft 12 and the lower end 22 of the second shaft 18 into the ground surface 24. The foot step 26 may include a first outer step section 28 and a second outer step section 30. The first outer step section 28 is attached to and extends outwardly from the first shaft 12 away from the second shaft 18. The second outer step section 30 is attached to and extends outwardly from the second shaft 18 away from the first shaft 12. The first 28 and second 30 outer step sections are aligned relative to each other. The foot step 26 may further include a medial step section 32 attached to and extending between the first 28 and second 30 outer step sections. The medial step section 32 extends between the first shaft 12 and the second shaft 18.

A support assembly 34 is provided and may be integrally coupled to each of the top end 14 of the first shaft 12 and the upper end 20 of the second shaft 18. The support assembly 34 is configured for receiving a fishing rod 36 and supporting the fishing rod 36 above the ground surface 24. The support assembly 34 includes a first end 38, a second end 40 and a pair of side members 42, 44 attached to and extending between the first end 38 and the second end 40. The first end 38 is elongated and tubular. The first end 38 may be attached to and extend between the top end 14 of the first shaft 12 and the upper end 20 of the second shaft 18. The second end 40 of the support assembly 34 is spaced above and laterally offset from the first end 38 of the support assembly 34. The second end 40 of the support assembly 34 may be concavely arcuate between the pair of side members 42, 44 wherein the second end 40 of the support assembly 34 defines a cradle 46 configured for receiving an upper section 48 of a handle 50 of the fishing rod 36. The first end 38 of the support assembly 34 has a lower surface 52 configured for abutting a lower section 54 of the handle 50 of the fishing rod 36 such that the first end 38 of the support assembly 34 defines a stabilizer 56 for stabilizing the lower section 54 of the handle 50 of the fishing rod 36. The side members 42, 44 of the support assembly 34 each include a lower bend 58, 60 positioned proximate the first end 38 of the support assembly 12. The side members 42, 44 curve upwardly away from the first 12 and second 18 shafts outwardly toward the second end 40 of the support assembly 34 at the lower bends 58, 60. The side members 42, 44 each include an upper bend 62, 64 positioned proximate the second end 40 of the support assembly 34. The side members 42, 44 extend straight out from the upper bends 62, 64 toward the second end 40 of the support assembly 34.

The foot step 26 may be positioned approximately 20.0 to 26.0 cm above each of the bottom end 16 of the first shaft 12 and the lower end 22 of the second shaft 18. The stabilizer 56 may be positioned approximately 30.0 to 40.0 cm above each of the bottom end 16 of the first shaft 12 and the lower end 22 of the second shaft 18.

In use, the bottom end 16 of the first shaft 12 and the lower end 22 of the second shaft 18 is positioned against the ground surface 24 such that the bottom end 16 and the lower end 22 are each pointed toward the ground surface 24. The foot step 26 is stepped upon in order to provide downward pressure on the first 12 and second 18 shafts to drive the bottom end 16 and the lower end 22 into the ground surface 24 until the foot step 26 is approximately equal with the ground surface 24. A fishing rod 36 is positioned on the support assembly 34 as described above such that the upper section 48 of the handle 50 rests on the cradle 46 while the lower surface 52 of first end 38 of the support assembly 34 abuts the lower section 54 of the handle 50 to stabilize the lower section 54 of the handle 50. In this manner, the device 10 holds and supports the fishing rod 36 above the ground surface 24.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fishing rod holder device comprising:
a first shaft having a top end and a bottom end;
a second shaft having an upper end and a lower end, said second shaft being positioned in spaced parallel relationship relative to said first shaft, said bottom end of said first shaft and said lower end of said second shaft being configured for insertion into a ground surface for elevating said top end of said first shaft and said upper end of said second shaft above the ground surface; and
a support assembly coupled to said top end of said first shaft and said upper end of said second shaft, said support assembly being configured for receiving a fishing rod and supporting the fishing rod above the ground surface.

2. The device of claim 1, further comprising each of said bottom end of said first shaft and said lower end of said second shaft being pointed.

3. The device of claim 1, further comprising a foot step attached to each of said first shaft and said second shaft, said foot step being positioned between said top end and said bottom end of said first shaft and between said upper end and said lower end of said second shaft wherein exerting pressure on said foot step is configured to drive said bottom end of said first shaft and said lower end of said second shaft into the ground surface.

4. The device of claim 3, further comprising wherein said foot step includes:
a first outer step section attached to and extending outwardly from said first shaft away from said second shaft;
a second outer step section attached to and extending outwardly from said second shaft away from said first shaft, said first and second outer step sections being aligned relative to each other; and
a medial step section attached to and extending between said first and second outer step sections, said medial step section extending between said first shaft and said second shaft.

5. The device of claim 1, further comprising wherein said support assembly is integrally coupled to each of said first shaft and said second shaft.

6. The device of claim 1, further comprising wherein said support assembly includes a first end, a second end and a pair of side members attached to and extending between said first end and said second end, said first end being tubular and elongated, said first end being attached to and extending between said top end of said first shaft and said upper end of said second shaft.

7. The device of claim 6, further comprising said second end of said support assembly being spaced above and laterally offset from said first end of said support assembly.

8. The device of claim 6, further comprising said second end of said support assembly being concavely arcuate between said pair of side members wherein said second end of said support assembly defines a cradle configured for receiving an upper section of a handle of the fishing rod.

9. The device of claim 7, further comprising said second end of said support assembly being concavely arcuate between said pair of side members wherein said second end of said support assembly defines a cradle configured for receiving an upper section of a handle of the fishing rod, said first end of said support assembly having a lower surface configured for abutting a lower section of the handle of the fishing rod such that said first end of said support assembly defines a stabilizer for stabilizing the lower section of the handle of the fishing rod.

10. The device of claim 8, further comprising wherein said side members of said support assembly each include a lower bend positioned proximate said first end of said support assembly, said side members curving upwardly away from said first and second shafts outwardly toward said second end of said support assembly at said lower bends.

11. The device of claim 8, further comprising wherein said side members of said support assembly each include an upper bend positioned proximate said second end of said support assembly, said side members extending straight out from said upper bends toward said second end of said support assembly.

12. A fishing rod holder device comprising:
a first shaft having a top end and a bottom end, said bottom end of said first shaft being pointed;
a second shaft having an upper end and a lower end, said lower end of said second shaft being pointed, said second shaft being positioned in spaced parallel relationship relative to said first shaft, said bottom end of said first shaft and said lower end of said second shaft being configured for insertion into a ground surface for elevating said top end of said first shaft and said upper end of said second shaft above the ground surface;
a foot step attached to each of said first shaft and said second shaft, said foot step being positioned between said top end and said bottom end of said first shaft and between said upper end and said lower end of said second shaft wherein exerting pressure on said foot step is configured to drive said bottom end of said first shaft and said lower end of said second shaft into the ground surface, said foot step including;
a first outer step section attached to and extending outwardly from said first shaft away from said second shaft;
a second outer step section attached to and extending outwardly from said second shaft away from said first shaft, said first and second outer step sections being aligned relative to each other; and
a medial step section attached to and extending between said first and second outer step sections, said medial step section extending between said first shaft and said second shaft; and
a support assembly integrally coupled to said top end of said first shaft and said upper end of said second shaft, said support assembly being configured for receiving a fishing rod and supporting the fishing rod above the ground surface, said support assembly including a first end, a second end and a pair of side members attached to and extending between said first end and said second end, said first end being elongated and tubular, said first end being attached to and extending between said top end of said first shaft and said upper end of said second shaft, said second end of said support assembly being spaced above and laterally offset from said first end of said support assembly, said second end of said support assembly being concavely arcuate between said pair of side members wherein said second end of said support assembly defines a cradle configured for receiving an upper section of a handle of the fishing rod, said first end of said support assembly having a lower surface configured for abutting a lower section of the handle of the fishing rod such that said first end of said support assembly defines a stabilizer for stabilizing the lower section of the handle of the fishing rod, said side members of said support assembly each including a lower bend positioned proximate said first end of said support assembly, said side members curving upwardly away from said first and second shafts outwardly toward said second end of said support assembly at said lower bends, said side members of said support assembly each including an upper bend positioned proximate said second end of said support assembly, said side members extending straight out from said upper bends toward said second end of said support assembly.
